(19) United States
(12) Patent Application Publication
(10) Pub. No.: US 2026/0340659 A1
(43) Pub. Date: Oct. 29, 2026

(54) ARTICLE IDENTIFICATION TAG, ARTICLE IDENTIFICATION SYSTEM, AND METHOD OF IDENTIFYING ARTICLE

(71) Applicant: Sumitomo Electric Industries, Ltd., Osaka-shi, Osaka (JP)

(72) Inventor: Tatsushige INABA, Osaka-shi, Osaka (JP)

(73) Assignee: Sumitomo Electric Industries, Ltd., Osaka-shi, Osaka (JP)

(21) Appl. No.: 19/101,595

(22) PCT Filed: Aug. 8, 2022
(86) PCT No.: PCT/JP2022/030242

§ 371 Date: Feb. 6, 2025

(51) Int. Cl. G06Q 30/018

(52) U.S. Cl. CPC G06Q 30/0185

(57) ABSTRACT

A tag for article identification according to the present disclosure is attached to an article, the tag comprising a first tag part that includes a fine substance representing a first identifier and a second tag part, it being possible to acquire a second identifier from the second tag part through a method that is different from the method for acquiring the first identifier from the first tag part.

### TECHNICAL FIELD

The present disclosure relates to an article identification tag, an article identification system, and a method of identifying an article.

### BACKGROUND ART

An individual identification device described below is disclosed in PTL 1 (Japanese Unexamined Patent Application Publication No. 2012-212288). That is, the individual identification device individually identifies an article including minute substances that have reflectivity different from that of a base material and that are randomly arranged on the base material. The individual identification device includes a storage means that extracts and stores, as reference characteristic data, information about the distribution positions of the minute substances that are added into a reference article, an object characteristic extraction means that extracts, as object characteristic data, information about the distribution positions of the minute substances that are added into an article to be identified, and a determination means that determines whether the article to be identified and the reference article are the same individual by comparing the object characteristic data that is extracted by the object characteristic extraction means and the reference characteristic data that is stored in the storage means.

An individual identification device described below is disclosed in PTL 2 (Japanese Unexamined Patent Application Publication No. 2022-10248). That is, the individual identification device includes a storage means that stores a position that represents a photographed location for individually identifying an object for every kind of the object to be individually identified, an overall information acquisition means that acquires overall information that is an image obtained by imaging the entire object, an identification means that identifies the kind of an object similar to the overall information, and an output means that outputs the stored position, based on the identified kind.

### CITATION LIST

### Patent Literature

PTL 1: Japanese Unexamined Patent Application Publication No. 2012-212288

PTL 2: Japanese Unexamined Patent Application Publication No. 2022-10248

### SUMMARY OF INVENTION

An article identification tag according to the present disclosure is an article identification tag attached to an article and includes a first tag portion including a minute substance representing a first identifier, and a second tag portion, and a second identifier is acquirable from the second tag portion by using a method different from a method in which the first identifier is acquired from the first tag portion.

### BRIEF DESCRIPTION OF DRAWINGS

FIG. 1 illustrates the structure of an article identification system according to an embodiment of the present disclosure.

FIG. 2 illustrates the structure of an article identification tag according to the embodiment of the present disclosure.

FIG. 3 illustrates the structure of the article identification tag according to the embodiment of the present disclosure.

FIG. 4 illustrates the structure of the article identification tag according to the embodiment of the present disclosure.

FIG. 5 illustrates an example of metadata that is generated by a registration device according to the embodiment of the present disclosure.

FIG. 6 illustrates an example of the sequence of an article identification process for the article identification system according to the embodiment of the present disclosure.

### DETAILED DESCRIPTION

An existing proposed technique is to make individual identification by using minute substances. For example, PTL 1 discloses a technique for determining whether the article to be identified and the reference article are the same individual by using the individual identification device that individually identifies the article including the minute substances that are randomly arranged.

### Problems to be Solved by Present Disclosure

There is a need for a technique that is superior to the techniques described in PTL 1 and PTL 2 and that enables an article to be individually identified flexibly depending on a difference between security levels that are requested in different scenes.

The present disclosure has been accomplished to solve the problems described above, and it is an object of the present disclosure to provide an article identification tag, an article identification system, and a method of identifying an article that enable the article to be individually identified flexibly depending on a difference between security levels that are requested in different scenes.

### Advantageous Effects of Present Disclosure

According to the present disclosure, an article can be individually identified flexibly depending on a difference between security levels that are requested in different scenes.

### Description of Embodiment of Present Disclosure

The content of an embodiment of the present disclosure will be first listed and described.
(1) An article identification tag according to an embodiment of the present disclosure is an article identification tag attached to an article and includes a first tag portion including a minute substance representing a first identifier, and a second tag portion, and a second identifier is acquirable from the second tag portion by using a method different from a method in which the first identifier is acquired from the first tag portion.

A structure that includes the first tag portion including the minute substance representing the first identifier, and the second tag portion from which the second identifier is acquirable by using the method different from the method in which the first identifier is acquired enables individual identification by selectively using the first identifier and the second identifier depending on the identifier acquirable from a required security level and the article identification tag in a scene in which the article is individually identified.

Accordingly, the article can be individually identified flexibly depending on a difference between security levels that are requested in different scenes.
(2) The second tag portion may include a code representing the second identifier in (1) described above.

With this structure, the second identifier can be acquired from the article identification tag by using a simple reading device that is capable of reading the code, and accordingly, the individual identification can be easily made by using the second identifier at low costs, for example, in a scene in which the requested security level is low.
(3) The second tag portion may be provided on a surface of the first tag portion facing the article, and the code in the second tag portion may be optically readable through the first tag portion in (2) described above.

With this structure, the size of the article identification tag can be smaller than that in a structure in which the first tag portion and the second tag portion are side by side arranged on the article. The use of a reading device that is capable of acquiring both of the first identifier and the second identifier by optically reading the pattern of the minute substance in the first tag portion and the code in the second tag portion enables the individual identification to be made by using both of the first identifier and the second identifier while the number of times of a reading process including two times of positioning and focusing of the reading device is decreased to once.
(4) The article identification tag in (2) or (3) described above may further include a third tag portion, a third identifier may be acquirable from the third tag portion by using a method different from the method in which the first identifier is acquired from the first tag portion, and the third tag portion may include a wireless tag representing the third identifier.

With this structure, the individual identification can be made by selectively using the first identifier, the second identifier, and the third identifier depending on the identifier acquirable from the required security level and the article identification tag in the scene in which the article is individually identified.
(5) The third tag portion may be provided on a surface of the second tag portion facing the article in (4) described above.

With this structure, the size of the article identification tag can be smaller than that in a structure in which the second tag portion and the third tag portion are arranged side by side on the article.
(6) The second tag portion may include a wireless tag representing the second identifier in (1) described above.

With this structure, the third identifier can be acquired from the article identification tag by using a simple reading device that is capable of acquiring the third identifier from the wireless tag, and accordingly, the individual identification can be easily made by using the third identifier at low costs, for example, in a scene in which the requested security level is low.
(7) An article identification system according to the embodiment of the present disclosure is an article identification system for identifying an article to which an article identification tag is attached, the article identification tag includes a first tag portion including a minute substance representing a first identifier, and a second tag portion, a second identifier is acquirable from the second tag portion by using a method different from a method in which the first identifier is acquired from the first tag portion, and the article identification system includes a first device configured to associate the first identifier and the second identifier with article information about the article and to register the first identifier and the second identifier in a database, and a second device configured to give at least the first identifier acquired from the first tag portion or the second identifier acquired from the second tag portion to the database and to acquire the article information.

This structure in which the first identifier and the second identifier are associated with the article information and are registered in the database, at least the first identifier acquired from the first tag portion or the second identifier acquired from the second tag portion is given to the database, and the article information is acquired enables multiple devices to share the article information by using the database. In addition, the article information is acquired by selectively using the first identifier and the second identifier depending on the identifier acquirable from the required security level and the article identification tag in the scene in which the article is individually identified, and the individual identification can be made by using the acquired article information. Accordingly, the article can be individually identified flexibly depending on the difference between the security levels that are requested in the different scenes.
(8) The second tag portion may include a code representing the second identifier. the second tag portion may be provided on a surface of the first tag portion facing the article, and the article identification system may include a reading device configured to acquire both of the first identifier and the second identifier by optically reading the code and a pattern of the minute substance in the first tag portion in (7) described above.

With this structure, the size of the article identification tag can be smaller than that in the structure in which the first tag portion and the second tag portion are arranged side by side on the article. In addition, both of the first identifier and the second identifier are acquired while the number of times of the reading process including two times of positioning and focusing of the reading device is decreased to once, and the individual identification can be made by using the first identifier and the second identifier.
(9) The database may be provided by an autonomous decentralized system in (7) or (8) described above.

With this structure, resistance against a failure in the database can be improved.
(10) The first device may be configured to register publishable information that is a part of the article information in the database in (9) described above.

With this structure, the publishable information can be selectively shared with another device with the confidential information protected.
(11) A method of identifying an article according to the embodiment of the present disclosure is a method of identifying an article for an article identification system configured to identify the article to which an article identification tag is attached, the article identification tag includes a first tag portion including a minute substance representing a first identifier, and a second tag portion, a second identifier is acquirable from the second tag portion by using a method different from a method in which the first identifier is acquired from the first tag portion, and the method of identifying the article includes a first device associating the first identifier and the second identifier with article information about the article and registering the first identifier and the second identifier in a database, and a second device giving at least the first identifier acquired from the first tag portion or the second identifier acquired from the second tag portion to the database and acquiring the article information.

This method in which the first identifier and the second identifier are associated with the article information and are registered in the database, at least the first identifier acquired from the first tag portion or the second identifier acquired from the second tag portion is given to the database, and the article information is acquired enables multiple devices to share the article information by using the database. In addition, the article information is acquired by selectively using the first identifier and the second identifier depending on the identifier acquirable from the required security level and the article identification tag in the scene in which the article is individually identified, and the individual identification can be made by using the acquired article information. Accordingly, the article can be individually identified flexibly depending on the difference between the security levels that are requested in the different scenes.

An embodiment of the present disclosure will now be described with reference to the drawings. In the drawings, portions like or corresponding to each other are designated by like reference signs, and the description thereof is not repeated. At least portions of the embodiment described below may be freely combined with each other.

### Structure and Basic Operation

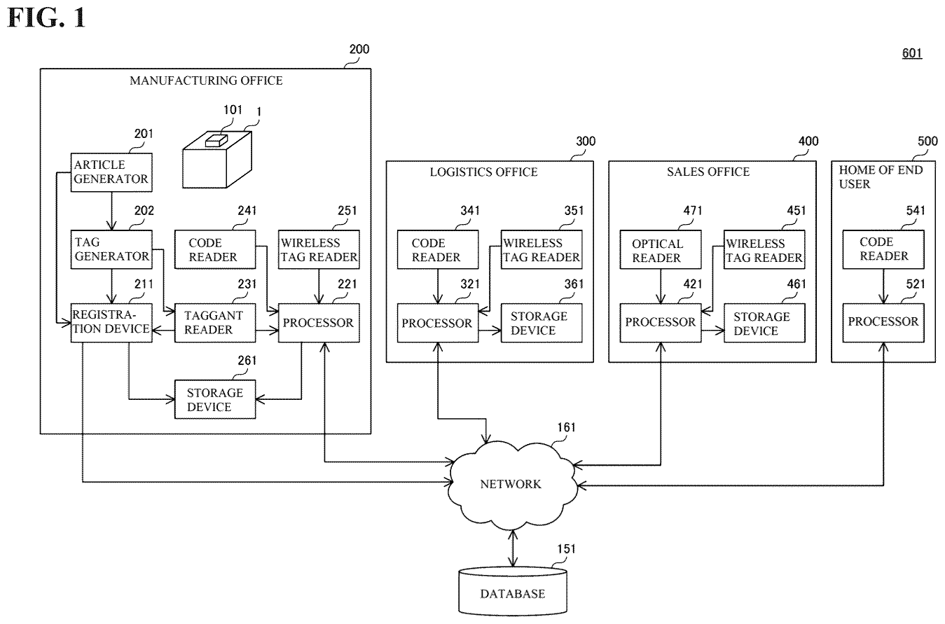

FIG. 1 illustrates the structure of an article identification system according to the embodiment of the present disclosure. Referring to FIG. 1, an article identification system 601 includes an article generator 201, a tag generator 202, a registration device 211, processors 221, 321, 421, and 521, a taggant reader 231, code readers 241, 341, and 541, wireless tag readers 251, 351, and 451, an optical reader 471, storage devices 261, 361, and 461, and a database 151. The registration device 211 is an example of a first device. The processors 221, 321, 421, and 521 are examples of a second device. The optical reader 471 is an example of a reading device.

The article identification system 601 identifies an article 1 to which an article identification tag 101 is attached. The article identification system 601 fulfills the traceability of the article 1 in a supply chain by individually identifying the article 1 with the article identification tag 101. The article 1 may be a product, may be the material of a product, may be equipment, or may be a package product in which any of these is contained.

For example, the article generator 201, the tag generator 202, the registration device 211, the processor 221, the taggant reader 231, the code reader 241, the wireless tag reader 251, and the storage device 261 are provided in a manufacturing office 200 of a manufacturer that manufactures the article 1, manages the quality of the article 1, ships the article 1, and so on. All or some of processes, described later, of the article generator 201, the tag generator 202, the registration device 211, the processor 221, the taggant reader 231, the code reader 241, and the wireless tag reader 251 are performed in response to an instruction from the manufacturer.

For example, the processor 321, the code reader 341, the wireless tag reader 351, and the storage device 361 are provided in a logistics office 300 of a logistics company that transports the article 1, delivers the article 1, and so on. All or some of processes, described later, of the processor 321, the code reader 341, and the wireless tag reader 351 described later are performed in response to an instruction from the logistics company.

For example, the processor 421, the optical reader 471, the wireless tag reader 451, and the storage device 461 are provided in a sales office 400 of a distributor that manages the stock of the article 1, sells the article 1, and so on. The distributor may be an agency, may be a wholesaler, or may be a retailer. All or some of processes, described later, of the processor 421, the optical reader 471, and the wireless tag reader 451 are performed in response to an instruction from the distributor.

For example, the processor 521 and the code reader 541 are provided in a home 500 of an end user of the article 1. An example of the code reader 541 is a cellular phone including a camera. All or some of processes, described later, of the processor 521 and the code reader 541 are performed in response to an instruction from the end user.

The registration device 211 and the processors 221, 321, 421, and 521 are capable of accessing the database 151 through a network 161 and capable of referring information about the article 1 that is stored in the database 151. For example, the database 151 is provided by an autonomous decentralized system. More specifically, the database 151 is a decentralized database, a block chain, or a decentralized ledger.

### Article Identification Tag

The article identification tag 101 is attached to the article 1 with an adhesive, for example, interposed therebetween. The article identification tag 101 represents an identifier unique to the article 1 to which the article identification tag 101 is attached.

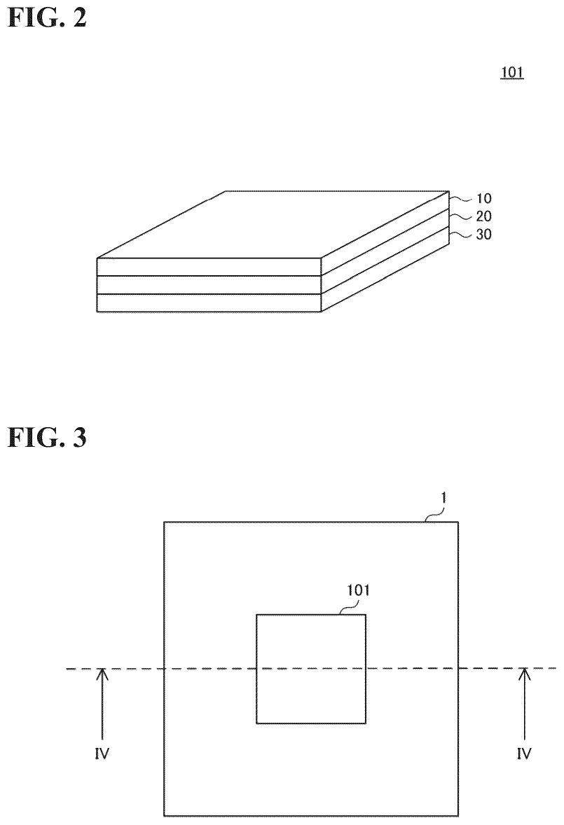

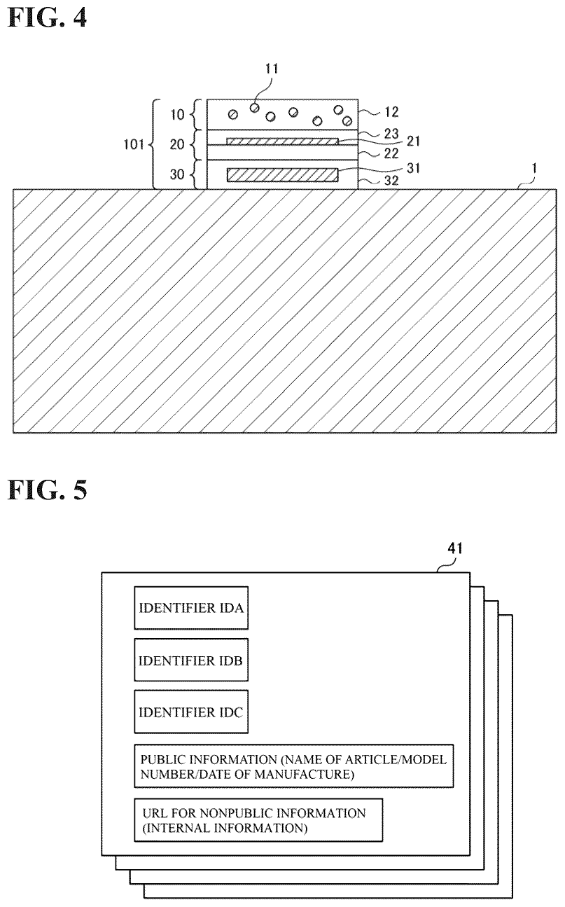

FIG. 2 to FIG. 4 illustrate the structure of the article identification tag according to the embodiment of the present disclosure. FIG. 2 is a perspective view of the article identification tag 101. FIG. 3 is a plan view of the article identification tag 101 that is attached to the article 1. FIG. 4 is a sectional view taken along a line IV-IV in FIG. 3.

Referring to FIG. 2 to FIG. 4, the article identification tag 101 includes a minute substance tag portion 10, a code tag portion 20, and a wireless tag portion 30. For example, the minute substance tag portion 10, the code tag portion 20, and the wireless tag portion 30 have a flat plate shape. The minute substance tag portion 10 is an example of a first tag portion. The code tag portion 20 is an example of a second tag portion. The wireless tag portion 30 is an example of a third tag portion.

The code tag portion 20 is provided on a surface of the minute substance tag portion 10 facing the article 1. The wireless tag portion 30 is provided on a surface of the code tag portion 20 facing the article 1. More specifically, the code tag portion 20 is provided so as to overlap, for example, the minute substance tag portion 10 between the minute substance tag portion 10 and the article 1 with the article identification tag 101 attached to the article 1. The wireless tag portion 30 is provided so as to overlap, for example, the code tag portion 20 between the code tag portion 20 and the article 1 with the article identification tag 101 attached to the article 1. That is, the article identification tag 101 has a multilayer structure in which the wireless tag portion 30, the code tag portion 20, and the minute substance tag portion 10 are arranged in this order from the article 1 with the article identification tag 101 attached to the article 1. For example, the article identification tag 101 is attached to the article 1 after the wireless tag portion 30, the code tag portion 20, and the minute substance tag portion 10 are generated by being stacked in this order. The article identification tag 101 may be formed on a surface of the article 1 in a manner in which the wireless tag portion 30, the code tag portion 20, and the minute substance tag portion 10 are stacked in this order from the article 1.

### (Minute Substance Tag Portion)

The minute substance tag portion 10 includes a resin layer 12 and multiple minute substances 11 that are provided in the resin layer 12. For example, the size of each minute substance 11 has a value in the range from several u meters to several hundred u meters. The resin layer 12 is composed of transparent resin.

The arrangement of the multiple minute substances 11 described above or the crystal orientation of the multiple minute substances 11 described above in the minute substance tag portion 10 represents the identifier IDA of the article 1. More specifically, a unique characteristic value is extracted from the arrangement of the minute substances 11 or the crystal orientation of the minute substances 11 in the minute substance tag portion 10 of the article identification tag 101, and the characteristic value is converted into the unique identifier IDA by using a digital process in which machine learning and number theory, for example, are used. For example, the amount of information about the identifier IDA is 128 bits. The identifier IDA is an example of a first identifier.

The identifier IDA of the article 1 is acquirable in a manner in which the arrangement of the minute substances 11 or the crystal orientation of the minute substances 11 in the minute substance tag portion 10 of the article identification tag 101 that is attached to the article 1 is optically read by using the taggant reader 231 or the optical reader 471, the characteristic value is extracted from the read arrangement or crystal orientation, and the characteristic value is converted by using the digital process described above.

For example, the density, size, and transmittance of the minute substances 11 in the minute substance tag portion 10 are designed so as to have values that enable a two-dimensional code 21 to be optically readable by the optical reader 471 and the code readers 241, 341, and 541 through the minute substance tag portion 10. For example, the minute substances 11 are composed of colorless minerals such as diamond and quartz and have a size of 100 u meters or less.

### (Code Tag Portion)

The code tag portion 20 includes the two-dimensional code 21, a base material 22, and a cover material 23. The two-dimensional code 21 is printed on a main surface of the base material 22 facing the minute substance tag portion 10. The cover material 23 covers the two-dimensional code 21 that is printed on the base material 22.

The two-dimensional code 21 represents the identifier IDB of the article 1. More specifically, the two-dimensional code 21 in the code tag portion 20 of the article identification tag 101 represents the identifier IDB unique to the article 1 to which the article identification tag 101 is attached. For example, the amount of information about the identifier IDB is 128 bits. A QR code (registered trademark) and Data Matrix are examples of the two-dimensional code 21. The identifier IDB is an example of a second identifier.

As for the article identification tag 101, the identifier IDB is acquirable from the code tag portion 20 by using a method different from a method in which the identifier IDA is acquired from the minute substance tag portion 10. More specifically, the identifier IDB of the article 1 is acquirable in a manner in which the two-dimensional code 21 in the code tag portion 20 of the article identification tag 101 that is attached to the article 1 is optically read by using the optical reader 471 or the code reader 241, 341, or 541, and a symbol of the read two-dimensional code 21 is converted into a character string. For example, the two-dimensional code 21 is optically readable through the minute substance tag portion 10.

### (Wireless Tag Portion)

The wireless tag portion 30 includes a wireless tag 31 and a cover material 32.

The cover material 32 covers the wireless tag 31.

The wireless tag 31 represents the identifier IDC of the article 1. More specifically, the wireless tag 31 in the wireless tag portion 30 of the article identification tag 101 represents the identifier IDC unique to the article 1 to which the article identification tag 101 is attached. The wireless tag 31 includes an antenna and an integrated circuit complying with RFID (Radio Frequency IDentifier). For example, the amount of information about the identifier IDC is 128 bits. The identifier IDC is an example of a third identifier.

As for the article identification tag 101, the identifier IDC is acquirable from the wireless tag portion 30 by using a method different from the method in which the identifier IDA is acquired from the minute substance tag portion 10. More specifically, the identifier IDC of the article 1 is acquirable from the wireless tag 31 in a manner in which a radio wave at a predetermined frequency is transmitted to the wireless tag 31 in the wireless tag portion 30 of the article identification tag 101 that is attached to the article 1 by using the wireless tag reader 251, 351, or 451.

### Process in Manufacturing Office

### (Register of Metadata)

Referring to FIG. 1 again, for example, the article generator 201 regularly generates the article 1. The article generator 201 transmits article information about the generated article 1 to the registration device 211 and transmits a tag creation instruction that represents that the article identification tag 101 that is attached to the article 1 is to be created to the tag generator 202. For example, the article information includes the name of the article 1, the model number of the article 1, the date of manufacture of the article 1, and internal information about the article 1. The internal information is confidential information that should not be published from the manufacturing office 200.

For example, the article generator 201 generates an article 1A that is the article 1, transmits article information about the article 1A to the registration device 211, and transmits a tag creation instruction that represents that the article identification tag 101 that is attached to the article 1A is to be created to the tag generator 202.

The registration device 211 associates the article information that is received from the article generator 201 with the article 1A and causes the storage device 261 to store the article information.

The tag generator 202 receives the tag creation instruction from the article generator 201 and generates the article identification tag 101 that represents an identifier unique to the article 1A.

More specifically, the tag generator 202 determines the identifiers IDB and IDC unique to the article 1A. The tag generator 202 prints the two-dimensional code 21 that represents the determined identifier IDB on the base material 22 and generates the code tag portion 20 by covering the two-dimensional code 21 that is printed on the base material 22 by using the cover material 23. The tag generator 202 also generates the wireless tag portion 30 that includes the wireless tag 31 on which the determined identifier IDC is written and stacks the generated wireless tag portion 30 on the code tag portion 20. The tag generator 202 mixes the minute substances 11 with resin that is the material of the resin layer 12, applies the resin with which the minute substances 11 are mixed to the code tag portion 20, hardens the resin, and consequently generates the minute substance tag portion 10 in which the wireless tag portion 30, the code tag portion 20, and the minute substance tag portion 10 are stacked in this order. The tag generator 202 attaches the generated article identification tag 101 to the article 1A. The tag generator 202 may be configured to generate the minute substance tag portion 10 that has a predetermined degree or more of transparency by applying and hardening the resin with which the minute substances 11 are mixed in a plate or sheet shape and to stack the generated minute substance tag portion 10 on the code tag portion 20 instead of applying the resin with which the minute substances 11 are mixed to the code tag portion 20. The tag generator 202 may be configured to stack the wireless tag portion 30, the code tag portion 20, and the minute substance tag portion 10 on the article 1A in this order instead of attaching the article identification tag 101 to the article 1A after the article identification tag 101 is generated.

The tag generator 202 reports the determined identifiers IDB and IDC to the registration device 211 and transmits an instruction to read the generated article identification tag 101 to the taggant reader 231.

The taggant reader 231 receives the instruction to read from the tag generator 202 and acquires the identifier IDA unique to the article 1A by optically reading the pattern of the minute substances 11 in the minute substance tag portion 10 of the article identification tag 101 that is generated by the tag generator 202. The taggant reader 231 reports the acquired identifier IDA to the registration device 211.

FIG. 5 illustrates an example of metadata that is generated by the registration device according to the embodiment of the present disclosure. Referring to FIG. 5, the registration device 211 generates metadata 41 that includes the identifier IDA of the article 1A that is reported from the taggant reader 231, the identifiers IDB and IDC of the article 1A that are reported from the tag generator 202, public information that is a part of the article information about the article 1A that is received from the article generator 201, and a URL (Uniform Resource Locator) for acquiring nonpublic information that is a part of the article information that cannot be published. The public information corresponds to the name of the article 1, the model number of the article 1, and the date of manufacture of the article 1. The nonpublic information is internal information about the article 1. A person who has an access right to the nonpublic information can acquire the nonpublic information by using the URL.

The registration device 211 associates the identifier IDA that is reported from the taggant reader 231 and the identifiers IDB and IDC that are reported from the tag generator 202 with the article information about the article 1A and registers the identifier IDA and the identifiers IDB and IDC in the database 151. For example, the registration device 211 registers the public information in the article information and the URL for acquiring the nonpublic information in the article information in the database 151. More specifically, the registration device 211 generates the metadata 41 for every article 1 and stores the generated metadata 41 in the database 151 through the network 161.

### (Update of Metadata)

Referring to FIG. 1 again, for example, an inspection device, not illustrated, checks the quality of the article 1A to which the article identification tag 101 is attached and transmits quality information that represents the quality of the article 1A to the processor 221. The code reader 241 acquires the identifier IDB of the article 1A by optically reading the two-dimensional code 21 in the article identification tag 101 that is attached to the article 1A and reports the acquired identifier IDB to the processor 221.

The processor 221 receives the quality information about the article 1A from the inspection device, associates the received quality information with the article 1A, and causes the storage device 261 to store the quality information.

The processor 221 acquires the metadata 41 of the article 1A that includes the identifier IDB from the database 151 through the network 161 by transmitting a request for data that includes the identifier IDB that is reported from the code reader 241 to the database 151 through the network 161.

The processor 221 adds a URL for acquiring the quality information about the article 1A into the acquired metadata 41. The processor 221 updates the metadata 41 of the article 1A in the database 151 to the metadata 41 into which the URL is added through the network 161.

After the check of the quality of the article 1A ends, and the shipment of the article 1A is prepared, the taggant reader 231 acquires the identifier IDA of the article 1A by optically reading the pattern of the minute substances 11 in the article identification tag 101 that is attached to the article 1A and reports the acquired identifier IDA to the processor 221. The code reader 241 acquires the identifier IDB of the article 1A by optically reading the two-dimensional code 21 in the article identification tag 101 that is attached to the article 1A and reports the acquired identifier IDB to the processor 221. The wireless tag reader 251 acquires the identifier IDC of the article 1A by transmitting a radio wave to the wireless tag 31 in the article identification tag 101 that is attached to the article 1A and reports the acquired identifier IDC to the processor 221.

The processor 221 acquires the metadata 41 that includes the identifier IDA from the database 151 through the network 161 by transmitting a request for data that includes the identifier IDA of the article 1A that is reported from the taggant reader 231 to the database 151 through the network 161.

The processor 221 collates the identifier IDB that is included in the acquired metadata 41 and the identifier IDB of the article 1A that is reported from the code reader 241 and collates the identifier IDC that is included in the acquired metadata 41 and the identifier IDC of the article 1A that is reported from the wireless tag reader 251.

In the case where the identifier IDB that is included in the metadata 41 and the identifier IDB that is reported from the code reader 241 do not match each other, the processor 221 determines that the two-dimensional code 21 in the article identification tag 101 that is attached to the article 1A is counterfeited or a failure occurs when the two-dimensional code 21 is printed and reports the result of determination to an administrator in the manufacturing office 200. In the case where the identifier IDC that is included in the metadata 41 and the identifier IDC that is reported from the wireless tag reader 251 do not match each other, the processor 221 determines that the wireless tag 31 in the article identification tag 101 that is attached to the article 1A is counterfeited, or a failure occurs when the identifier IDC is written on the wireless tag 31 and reports the result of determination to the administrator in the manufacturing office 200.

In the case where the identifier IDB that is included in the metadata 41 and the identifier IDB that is reported from the code reader 241 match each other, and the identifier IDC that is included in the metadata 41 and the identifier IDC that is reported from the wireless tag reader 251 match each other, the processor 221 determines that the article identification tag 10 that is attached to the article 1A is normal and that the article 1A can be shipped.

In the case where it is determined that the article 1A can be shipped, the processor 221 adds shipment information that represents, for example, the date of shipment of the article 1A into the metadata 41 of the article 1A. The processor 221 updates the metadata 41 of the article 1A in the database 151 to the metadata 41 into which the shipment information is added through the network 161. The processor 221 associates the shipment information about the article 1A with the article 1A and causes the storage device 261 to store the shipment information.

### Process in Logistics Office

In the logistics office 300, the wireless tag reader 351 acquires the identifier IDC of the article 1 by transmitting a radio wave to the wireless tag 31 in the article identification tag 101 that is attached to the article 1 and reports the acquired identifier IDC to the processor 321 after the article 1 arrives at the logistics office 300.

The processor 321 causes the storage device 361 to store management information that represents, for example, the number of the article 1 that arrives by using the identifier IDC that is reported from the wireless tag reader 351.

For example, the processor 321 acquires the metadata 41 of the article 1A that includes the identifier IDC from the database 151 through the network 161 by transmitting a request for data that includes the identifier IDC of the article 1A that is reported from the wireless tag reader 351 to the database 151 through the network 161.

The processor 321 adds arrival information that represents, for example, the date of arrival of the article 1A into the acquired metadata 41. The processor 321 updates the metadata 41 of the article 1A in the database 151 to the metadata 41 into which the arrival information is added through the network 161. The processor 321 associates the arrival information about the article 1A with the article 1A and causes the storage device 361 to store the arrival information.

After the delivery of the article 1 is prepared, the code reader 341 acquires the identifier IDB of the article 1 by optically reading the two-dimensional code 21 in the article identification tag 101 that is attached to the article 1 and reports the acquired identifier IDB to the processor 321.

The processor 321 updates the management information in the storage device 361 by using the identifier IDB that is reported from the code reader 341.

For example, the processor 321 acquires the metadata 41 of the article 1A that includes the identifier IDB from the database 151 through the network 161 by transmitting a request for data that includes the identifier IDB of the article 1A that is reported from the code reader 341 to the database 151 through the network 161.

The processor 321 adds tracking information that represents, for example, the destination of the article 1A into the acquired metadata 41. The processor 321 updates the metadata 41 of the article 1A in the database 151 to the metadata 41 into which the tracking information is added through the network 161. The processor 321 associates the tracking information about the article 1A with the article 1A and causes the storage device 361 to store the tracking information.

### Process in Sales Office

The processor 421 in the sales office 400 determines authenticity of the article 1 by using the identifiers IDA, IDB, and IDC of the article 1.

More specifically, the optical reader 471 acquires the identifiers IDA and IDB of the article 1 by optically reading the two-dimensional code 21 and the pattern of the minute substances 11 in the article identification tag 101 that is attached to the article 1 after the article 1 arrives at the sales office 400. The two-dimensional code 21 is optically readable through the minute substance tag portion 10 as described above, and accordingly, the optical reader 471 is capable of acquiring the identifiers IDA and IDB by performing a single reading process. The optical reader 471 reports the acquired identifiers IDA and IDB to the processor 421.

The wireless tag reader 451 acquires the identifier IDC of the article 1 by transmitting a radio wave to the wireless tag 31 in the article identification tag 101 that is attached to the article 1 and reports the acquired identifier IDC to the processor 421.

The processor 421 gives the identifier IDA that is acquired from the minute substance tag portion 10 to the database 151 and acquires the article information.

More specifically, the processor 421 tries to acquire the metadata 41 that includes the identifier IDA and the article information by transmitting a request for data that includes the identifier IDA that is reported from the optical reader 471 to the database 151 through the network 161.

In the case where the metadata 41 that includes the identifier IDA cannot be acquired from the database 151 through the network 161, the processor 421 determines that the article 1 is counterfeit.

In the case where the metadata 41 that includes the identifier IDA can be acquired from the database 151 through the network 161, the processor 421 collates the identifier IDB that is included in the acquired metadata 41 and the identifier IDB that is reported from the optical reader 471 and collates the identifier IDC that is included in the acquired metadata 41 and the identifier IDC that is reported from the wireless tag reader 451.

In the case where the identifier IDB that is included in the metadata 41 and the identifier IDB that is reported from the optical reader 471 do not match each other, or the identifier IDC that is included in the metadata 41 and the identifier IDC that is reported from the wireless tag reader 451 do not match each other, the processor 421 determines that the article 1 is counterfeit.

In the case where the identifier IDB that is included in the metadata 41 and the identifier IDB that is reported from the optical reader 471 match each other, and the identifier IDC that is included in the metadata 41 and the identifier IDC that is reported from the wireless tag reader 451 match each other, the processor 421 determines that the article 1 is not counterfeit but is authentic.

For example, in the case where it is determined that the article 1 is authentic, the processor 421 causes the storage device 461 to store information that represents, for example, the amount of stock and the number of the article 1 that arrives by using the identifiers IDA, IDB, and IDC.

The processor 421 may be configured to give the identifier IDB or the identifier IDC to the database 151 instead of the identifier IDA and to acquire the article information. For example, the processor 421 tries to acquire the metadata 41 that includes the identifier IDB by transmitting a request for data that includes the identifier IDB that is reported from the optical reader 471 to the database 151 through the network 161. In this case, the processor 421 determines whether the metadata 41 can be acquired and whether the article 1 is authentic, based on the result of collation of the identifiers IDA and IDC that are included in the acquired metadata 41 and the identifiers IDA and IDC that are reported from the optical reader 471 and the wireless tag reader 451. Alternatively, the processor 421 tries to acquire the metadata 41 that includes the identifier IDC by transmitting a request for data that includes the identifier IDC that is reported from the wireless tag reader 451 to the database 151 through the network 161. In this case, the processor 421 determines whether the metadata 41 can be acquired and whether the article 1 is authentic, based on the result of collation of the identifiers IDA and IDB that are included in the acquired metadata 41 and the identifiers IDA and IDB that are reported from the optical reader 471.

For example, the optical reader 471 acquires the identifier IDB of the article 1A by optically reading the two-dimensional code 21 in the article identification tag 101 that is attached to the article 1A after a contract for sale of the article 1A is made and reports the acquired identifier IDB to the processor 421.

For example, the processor 421 acquires the metadata 41 of the article 1A that includes the identifier IDB from the database 151 through the network 161 by transmitting a request for data that includes the identifier IDB that is reported from the optical reader 471 to the database 151 through the network 161.

The processor 421 adds sales information that represents, for example, the date of sale and the destination of sale of the article 1A into the acquired metadata 41. The processor 321 updates the metadata 41 of the article 1A in the database 151 to the metadata 41 to which the sales information is added through the network 161. The processor 421 associates the sales information about the article 1A with the article 1A and causes the storage device 461 to store the sales information.

### Process in Home of End User

The processor 521 in the home 500 of the end user determines the authenticity of the article 1 by using the identifier IDB of the article 1.

More specifically, the code reader 541 acquires the identifier IDB of the article 1 by optically reading the two-dimensional code 21 in the article identification tag 101 that is attached to the article 1 in accordance with a user operation after the article 1 is delivered to the home 500 of the end user and reports the acquired identifier IDB to the processor 521.

The processor 521 gives the identifier IDB that is acquired from the code tag portion 20 to the database 151 and acquires the article information.

More specifically, the processor 521 tries to acquire the article information about the article 1 that includes the identifier IDB by transmitting a request for data that includes the identifier IDB that is reported from the code reader 541 to the database 151 through the network 161.

In the case where the article information about the article 1 that includes the identifier IDB can be acquired from the database 151 through the network 161, the processor 521 determines that the article 1 is not counterfeit but is authentic. In the case where the article information about the article 1 that includes the identifier IDB cannot be acquired from the database 151 through the network 161, the processor 521 determines that the article 1 is counterfeit. The processor 521 reports the result of determination about the determination of the authenticity of the article 1 to the user.

For example, in the case where the result of determination is reported from the processor 521, and the user wishes to more strictly determine the authenticity, the user delivers the article 1 to the manufacturing office 200 or the sales office 400 and requests the determination of the authenticity.

### Determination of Authenticity in Manufacturing Office

In the manufacturing office 200 that is requested by the user to determine the authenticity of the article 1, the taggant reader 231 acquires the identifier IDA of the article 1 by optically reading the pattern of the minute substances 11 in the article identification tag 101 that is attached to the article 1 and reports the acquired identifier IDA to the processor 221. The code reader 241 acquires the identifier IDB of the article 1 by optically reading the two-dimensional code 21 in the article identification tag 101 that is attached to the article 1 and reports the acquired identifier IDB to the processor 221. The wireless tag reader 251 acquires the identifier IDC of the article 1 by transmitting a radio wave to the wireless tag 31 in the article identification tag 101 that is attached to the article 1 and reports the acquired identifier IDC to the processor 221.

The processor 221 determines the authenticity of the article 1 by using the identifiers IDA, IDB, and IDC that are reported from the taggant reader 231, the code reader 241, and the wireless tag reader 251.

More specifically, the processor 221 tries to acquire the metadata 41 that includes the identifier IDA by transmitting a request for data that includes the identifier IDA that is reported from the taggant reader 231 to the database 151 through the network 161.

In the case where the metadata 41 that includes the identifier IDA cannot be acquired from the database 151 through the network 161, the processor 221 determines that the article 1 is counterfeit.

In the case where the metadata 41 that includes the identifier IDA can be acquired from the database 151 through the network 161, the processor 221 collates the identifier IDB that is included in the acquired metadata 41 and the identifier IDB that is reported from the code reader 241 and collates the identifier IDC that is included in the acquired metadata 41 and the identifier IDC that is reported from the wireless tag reader 251.

In the case where the identifier IDB that is included in the metadata 41 and the identifier IDB that is reported from the code reader 241 do not match each other, or the identifier IDC that is included in the metadata 41 and the identifier IDC that is reported from the wireless tag reader 251 do not match each other, the processor 221 determines that the article 1 is counterfeit.

In the case where the identifier IDB that is included in the metadata 41 and the identifier IDB that is reported from the code reader 241 match each other, and the identifier IDC that is included in the metadata 41 and the identifier IDC that is reported from the wireless tag reader 251 match each other, the processor 221 determines that the article 1 is not counterfeit but is authentic.

The processor 221 reports the result of determination about the determination of the authenticity of the article 1 to an administrator in the manufacturing office 200. The administrator reports the result of determination to the user by which the determination of the authenticity is requested.

The processor 221 may be configured to give the identifier IDB or the identifier IDC to the database 151 instead of the identifier IDA and to acquire the article information. For example, the processor 221 tries to acquire the metadata 41 that includes the identifier IDB by transmitting a request for data that includes the identifier IDB that is reported from the code reader 241 to the database 151 through the network 161. In this case, the processor 221 determines whether the metadata 41 can be acquired and whether the article 1 is authentic, based on the result of collation of the identifiers IDA and IDC that are included in the acquired metadata 41 and the identifiers IDA and IDC that are reported from the taggant reader 231 and the wireless tag reader 251. Alternatively, the processor 221 tries to acquire the metadata 41 that includes the identifier IDC by transmitting a request for data that includes the identifier IDC that is reported from the wireless tag reader 251 to the database 151 through the network 161. In this case, the processor 221 determines whether the metadata 41 can be acquired and whether the article 1 is authentic, based on the result of collation of the identifiers IDA and IDB that are included in the acquired metadata 41 and the identifiers IDA and IDB that are reported from the taggant reader 231 and the code reader 241.

### Determination of Authenticity in Sales Office

In the sales office 400 that is requested by the user to determine the authenticity of the article 1, the optical reader 471 acquires the identifiers IDA and IDB of the article 1 by optically reading the two-dimensional code 21 and the pattern of the minute substances 11 in the article identification tag 101 that is attached to the article 1 and reports the acquired identifiers IDA and IDB to the processor 421. The wireless tag reader 451 acquires the identifier IDC of the article 1 by transmitting a radio wave to the wireless tag 31 in the article identification tag 101 that is attached to the article 1 and reports the acquired identifier IDC to the processor 421.

The processor 421 determines the authenticity of the article 1 by using the identifiers IDA, IDB, and IDC that are reported from the optical reader 471 and the wireless tag reader 451 in the same manner as when the article 1 arrives at the sales office 400.

The processor 421 reports the result of determination about the determination of the authenticity of the article 1 to an administrator in the sales office 400. The administrator reports the result of determination to the user by which the determination of the authenticity is requested.

### Flow of Operation

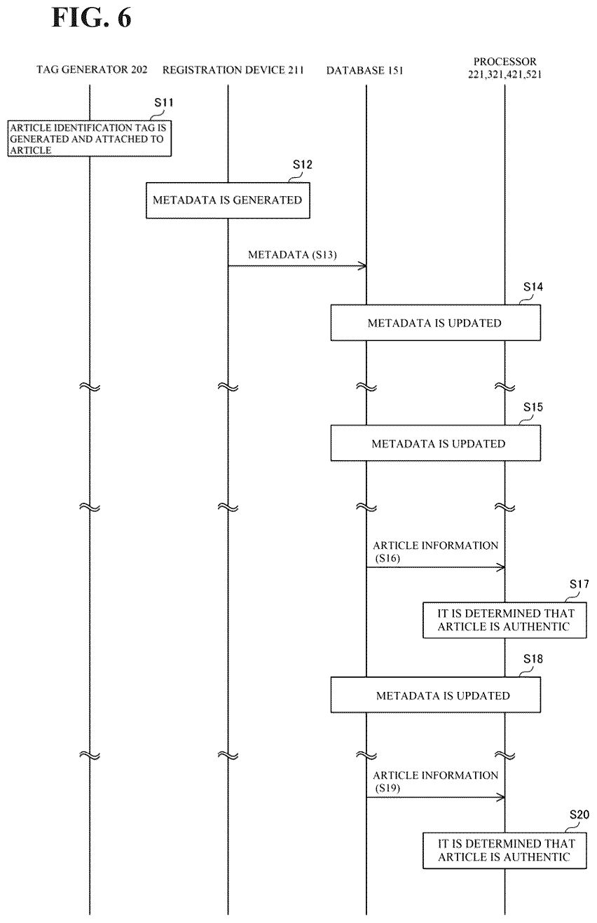

FIG. 6 illustrates an example of the sequence of an article identification process for the article identification system according to the embodiment of the present disclosure.

Referring to FIG. 6, the tag generator 202 first receives the tag creation instruction from the article generator 201, generates the article identification tag 101 that represents the identifier unique to the article 1, and attaches the article identification tag 101 to the article 1 (a step S11).

Subsequently, the registration device 211 generates the metadata 41 that includes the identifiers IDA, IDB, and IDC that are represented by the article identification tag 101 that is attached to the article 1, the public information about the article 1, and the URL for acquiring the nonpublic information about the article 1 (a step S12).

Subsequently, the registration device 211 associates the identifiers IDA, IDB, and IDC that are represented by the article identification tag 101 that is attached to the article 1 with the article information about the article 1 and registers the identifiers IDA, IDB, and IDC in the database 151. More specifically, the registration device 211 stores the generated metadata 41 in the database 151 through the network 161 (a step S13).

Subsequently, the processor 221 updates the metadata 41 in the database 151. More specifically, the processor 221 receives the quality information about the article 1 from the inspection device, not illustrated, and updates the metadata 41 of the article 1 in the database 151 to the metadata 41 into which the URL for acquiring the quality information is added. The processor 221 updates the metadata 41 of the article 1 in the database 151 to the metadata 41 into which the shipment information that represents, for example, the date of shipment of the article 1 is added after the shipment of the article 1 is prepared (a step S14).

Subsequently, the processor 321 updates the metadata 41 in the database 151. More specifically, the processor 321 updates the metadata 41 of the article 1 in the database 151 to the metadata 41 into which the arrival information that represents, for example, the date of arrival of the article 1 is added after the article 1 arrives at the logistics office 300. The processor 321 updates the metadata 41 of the article 1 in the database 151 to the metadata 41 into which the tracking information that represents, for example, the destination of the article 1 is added after the delivery of the article 1 is prepared (a step S15).

Subsequently, the processor 421 gives the identifier IDA of the article 1 to the database 151 after the article 1 arrives at the sales office 400 and acquires the article information. More specifically, the processor 421 acquires the metadata 41 that includes the identifier IDA by transmitting a request for data that includes the identifier IDA of the article 1 to the database 151 through the network 161 (a step S16).

Subsequently, in the case where the metadata 41 that includes the identifier IDA can be acquired from the database 151 through the network 161, and the identifiers IDB and IDC that are included in the acquired metadata 41 and the identifiers IDB and IDC that are represented by the article identification tag 101 that is attached to the article 1 match each other, the processor 421 determines that the article 1 is not counterfeit but is authentic (a step S17).

Subsequently, the processor 421 updates the metadata 41 in the database 151. More specifically, the processor 421 updates the metadata 41 of the article 1 in the database 151 to the metadata 41 into which the sales information that represents, for example, the date of sale and the destination of sale of the article 1 is added after a contract for sale of the article 1 is made (a step S18).

Subsequently, the processor 521 gives the identifier IDB of the article 1 to the database 151 after the article 1 is delivered to the home 500 of the end user and acquires the article information. More specifically, the processor 521 acquires the article information about the article 1 by transmitting a request for data that includes the identifier IDB of the article 1 to the database 151 through the network 161 (a step S19).

Subsequently, in the case where the article information about the article 1 can be acquired from the database 151 through the network 161, the processor 521 determines that the article 1 is not counterfeit but is authentic (a step S20).

The article identification tag 101 according to the embodiment of the present disclosure is configured to include the minute substance tag portion 10, the code tag portion 20, and the wireless tag portion 30 but is not limited thereto. The article identification tag 101 may be configured to include neither the code tag portion 20 nor the wireless tag portion 30. As for the article identification tag 101 that does not include the code tag portion 20, the wireless tag portion 30 is an example of the second tag portion, and the identifier IDC that is represented by the wireless tag portion 30 is an example of the second identifier.

The article identification tag 101 according to the embodiment of the present disclosure is configured to have a multilayer structure in which the wireless tag portion 30, the code tag portion 20, and the minute substance tag portion 10 are stacked in this order from the article 1 but is not limited thereto. The article identification tag 101 may be configured to have no multilayer structure. More specifically, the wireless tag portion 30 may be provided so as not to overlap the code tag portion 20. The code tag portion 20 may be provided so as not to overlap the minute substance tag portion 10.

As for the article identification tag 101 according to the embodiment of the present disclosure, the code tag portion 20 is configured to include the two-dimensional code 21 but is not limited thereto. The code tag portion 20 may be configured to include a one-dimensional code such as a barcode instead of the two-dimensional code 21.

As for the article identification system 601 according to the embodiment of the present disclosure, the optical reader 471 is configured to acquire the identifiers IDA and IDB of the article 1 by optically reading the two-dimensional code 21 and the pattern of the minute substances 11 in the article identification tag 101 but is not limited thereto. The optical reader 471 may be configured to acquire the identifier IDA by optically reading the pattern of the minute substances 11 in the article identification tag 101 but neither to read the two-dimensional code 21 nor to acquire the identifier IDB. In this case, the article identification system 601 may be configured to further include a code reader that is provided in the sales office 400 and that acquires the identifier IDB by optically reading the two-dimensional code 21.

As for the article identification system 601 according to the embodiment of the present disclosure, the database 151 is configured to be provided by the autonomous decentralized system but is not limited thereto. The database 151 may be configured to be provided by a centralized system.

As for the article identification system 601 according to the embodiment of the present disclosure, the registration device 211 is configured to register the public information in the article information and the URL for acquiring the nonpublic information in the article information in the database 151 but is not limited thereto. The registration device 211 may be configured to register the nonpublic information in the database 151 in addition to the public information.

As for the article identification system 601 according to the embodiment of the present disclosure, the processor 421 in the sales office 400 is configured to give the identifier IDA that is acquired from the minute substance tag portion 10 to the database 151 and to acquire the article information but is not limited thereto. The processor 421 may be configured to give the identifier IDB that is acquired from the code tag portion 20 to the database 151 instead of the identifier IDA and to acquire the article information. More specifically, the processor 421 tries to acquire the metadata 41 that includes the identifier IDB by transmitting a request for data that includes the identifier IDB that is reported from the optical reader 471 to the database 151 through the network 161. The processor 421 determines whether the metadata 41 can be acquired and whether the article 1 is authentic, based on the result of collation of the identifiers IDA and IDC that are included in the acquired metadata 41 and the identifiers IDA and IDC that are reported from the optical reader 471 and the wireless tag reader 451.

The processor 421 may be configured to give both of the identifier IDA and the identifier IDB to the database 151 and to acquire the article information. More specifically, the processor 421 tries to acquire the metadata 41 that includes the identifier IDA by transmitting a request for data that includes the identifier IDA to the database 151 through the network 161. The processor 421 also tries to acquire the metadata 41 that includes the identifier IDB by transmitting a request for data that includes the identifier IDB to the database 151 through the network 161. For example, in the case where the metadata 41 that includes the identifier IDA and the metadata 41 that includes the identifier IDB can be acquired, the processor 421 collates the article information in the metadata 41 that includes the identifier IDA and the article information in the metadata 41 that includes the identifier IDB and determines that the article 1 is authentic in the case where these match each other. In the case where these do not match each other, the processor 421 determines that the article 1 is counterfeit.

In some cases, different security levels are requested depending on scenes in which articles are individually identified, and there is a need for a technique that enables the articles to be individually identified flexibly depending on a difference between the security levels that are requested in the different scenes.

An existing proposed technique for, for example, a manufacturer, a logistics company, a distributor, and an end user involves individually identifying an object by using a one-dimensional code such as a barcode, a two-dimensional code such as a QR code, or a wireless tag. As for a method of individually identifying an article by using these, however, resistance against duplication and tampering is weak, and the reliability of the result of identification of an authentic article and a counterfeit article is poor accordingly, whereas the one-dimensional code, the two-dimensional code, and the wireless tag can be read by using a simple reading device. Accordingly, an individual identification technique with the one-dimensional code, the two-dimensional code, and the wireless tag is not appropriate to the determination of the authenticity of an article.

As for an individual identification technique described in PTL 1, the resistance against duplication and tampering is strong, but an exclusive, expensive reading device is needed. Accordingly, it is unrealistic that all of the end users and dealers which make the individual identification possess the reading device in the perspective of the costs and usability of the reading device.

In contrast, the article identification tag 101 according to the embodiment of the present disclosure is attached to the article 1. The article identification tag 101 includes the minute substance tag portion 10 that includes the minute substances 11 that represent the identifier IDA, the code tag portion 20, and the wireless tag portion 30. As for the article identification tag 101, the identifiers IDB and IDC are acquirable from the code tag portion 20 and the wireless tag portion 30 by using the methods different from the method in which the identifier IDA is acquired from the minute substance tag portion 10.

A structure that thus includes the minute substance tag portion 10 that includes the minute substances 11 that represent the identifier IDA, and the code tag portion 20 and the wireless tag portion 30 from which the identifiers IDB and IDC are acquirable by using the methods different from the method in which the identifier IDA is acquired enables the individual identification by selectively using the identifiers IDA, IDB, and IDC depending on the identifier acquirable from the required security level and the article identification tag 101 in a scene in which the article 1 is individually identified. Accordingly, the article can be individually identified flexibly depending on the difference between the security levels that are requested in the different scenes.

It is to be understood that the embodiment is described above by way of example in all aspects and is not restrictive. The scope of the present invention is not shown by the above description but by claims and includes all modifications having the same meaning and scope as those of the claims.

The above description contains features described below.

### [Additional Remark 1]

An article identification tag is attached to an article and includes a first tag portion including a minute substance representing a first identifier, and a second tag portion, a second identifier is acquirable from the second tag portion by using a method different from a method in which the first identifier is acquired from the first tag portion, the second tag portion includes a code representing the second identifier, the article identification tag further includes a third tag portion, a third identifier is acquirable from the third tag portion by using a method different from the method in which the first identifier is acquired from the first tag portion, the third tag portion includes a wireless tag representing the third identifier, and the first tag portion, the second tag portion, and the third tag portion are stacked in this order.

### [Additional Remark 2]

An article identification tag is attached to an article and includes a first tag portion including a minute substance representing a first identifier, and a second tag portion, a second identifier is acquirable from the second tag portion by using a method different from a method in which the first identifier is acquired from the first tag portion, the second tag portion includes a code representing the second identifier, the second tag portion is provided on a surface of the first tag portion facing the article, and the minute substance is composed of a colorless mineral.

[additional Remark 3]

An article identification tag is attached to an article and includes a first tag portion including a minute substance representing a first identifier, and a second tag portion, a second identifier is acquirable from the second tag portion by using a method different from a method in which the first identifier is acquired from the first tag portion, the second tag portion includes a code representing the second identifier, the second tag portion is provided on a surface of the first tag portion facing the article, and the size of the minute substance is 100μmeters or less.

### REFERENCE SIGNS LIST

1 article
10 minute substance tag portion
11 minute substance
12 resin layer
20 code tag portion
21 two-dimensional code
22 base material
23 cover material
30 wireless tag portion
31 wireless tag
32 cover material
41 metadata
101 article identification tag
151 database
161 network
200 manufacturing office
201 article generator
202 tag generator
211 registration device
221, 321, 421, 521 processor
231 taggant reader
241, 341, 541 code reader
251, 351, 451 wireless tag reader
261, 361, 461 storage device
471 optical reader
300 logistics office
400 sales office
500 home of end user
601 article identification system

1. An article identification tag attached to an article, the article identification tag comprising:
a first tag portion including a minute substance representing a first identifier; and
a second tag portion,
wherein the first identifier is acquirable by optically reading crystal orientation of the minute substance,
wherein a second identifier is acquirable from the second tag portion by using a method different from a method in which the first identifier is acquired from the first tag portion.

2. The article identification tag according to claim 1, wherein the second tag portion includes a code representing the second identifier.

3. The article identification tag according to claim 2, wherein the second tag portion is provided on a surface of the first tag portion facing the article, and
wherein the code in the second tag portion is optically readable through the first tag portion.

4. The article identification tag according to claim 2 further comprising:
a third tag portion,
wherein a third identifier is acquirable from the third tag portion by using a method different from the method in which the first identifier is acquired from the first tag portion, and
wherein the third tag portion includes a wireless tag representing the third identifier.

5. The article identification tag according to claim 4, wherein the third tag portion is provided on a surface of the second tag portion facing the article.

6. The article identification tag according to claim 1, wherein the second tag portion includes a wireless tag representing the second identifier.

7. An article identification system for identifying an article to which an article identification tag is attached,
the article identification tag including a first tag portion including a minute substance representing a first identifier, and a second tag portion, the first identifier being acquirable by optically reading crystal orientation of the minute substance and a second identifier being acquirable from the second tag portion by using a method different from a method in which the first identifier is acquired from the first tag portion,
the article identification system comprising:
a first device configured to associate the first identifier and the second identifier with article information about the article and to register the first identifier and the second identifier in a database; and
a second device configured to give at least the first identifier acquired from the first tag portion or the second identifier acquired from the second tag portion to the database and to acquire the article information.

8. The article identification system according to claim 7, wherein the second tag portion includes a code representing the second identifier,
wherein the second tag portion is provided on a surface of the first tag portion facing the article, and
wherein the article identification system comprises a reading device configured to acquire both of the first identifier and the second identifier by optically reading the code and a pattern of the minute substance in the first tag portion.

9. The article identification system according to claim 7, wherein the database is provided by an autonomous decentralized system.

10. The article identification system according to claim 9, wherein the first device is configured to register publishable information that is a part of the article information in the database.

11. A method of identifying an article for an article identification system configured to identify the article to which an article identification tag is attached,
the article identification tag including a first tag portion including a minute substance representing a first identifier, and a second tag portion, the first identifier being acquirable by optically reading crystal orientation of the minute substance and a second identifier being acquirable from the second tag portion by using a method different from a method in which the first identifier is acquired from the first tag portion,
the method of identifying the article comprising:
a first device associating the first identifier and the second identifier with article information about the article and registering the first identifier and the second identifier in a database; and
a second device giving at least the first identifier acquired from the first tag portion or the second identifier acquired from the second tag portion to the database and acquiring the article information.

12. The article identification tag according to claim 1, wherein the first tag portion further includes a transparent resin layer, and
wherein the minute substance is colorless and is provided in the transparent resin layer.

13. The article identification tag according to claim 7,
wherein the second device is configured to collate the second identifier corresponding to the acquired article information and the second identifier acquired from the second tag portion in a case where the second device gives the first identifier acquired from the first tag portion to the database and acquires the article information, and
wherein the second device is configured to collate the first identifier corresponding to the acquired article information and the first identifier acquired from the first tag portion in a case where the second device gives the second identifier acquired from the second tag portion to the database and acquires the article information.

14. An article identification system for identifying an article to which an article identification tag is attached,
the article identification tag including a first tag portion including a minute substance representing a first identifier, and a second tag portion, a second identifier being acquirable from the second tag portion by using a method different from a method in which the first identifier is acquired from the first tag portion,
the article identification system comprising:
a first device configured to register metadata that includes the first identifier, the second identifier, and article information about the article in a block chain; and
a second device configured to give at least the first identifier acquired from the first tag portion or the second identifier acquired from the second tag portion to the database and to acquire the article information,
wherein the second device is configured to determine whether the article is authentic by collating the second identifier included in the acquired metadata and the second identifier acquired from the second tag portion in a case where the second device gives the first identifier and acquires the article information,
wherein the second device is configured to determine whether the article is authentic by collating the first identifier included in the acquired metadata and the first identifier acquired from the first tag portion in a case where the second device gives the second identifier and acquires the article information, and
wherein the second device adds information into the metadata in the block chain in a case where it is determined that the article is authentic.
